(19) United States
(12) Patent Application Publication
(10) Pub. No.: US 2012/0290199 A1
(43) Pub. Date: Nov. 15, 2012

(54) APPARATUS, SYSTEM AND METHOD FOR SELF ORIENTATION

(76) Inventors: Dror Nadam, Ein Sarid (IL); Ronen Padowicz, Herzliya (IL)

(21) Appl. No.: 13/509,069

(22) PCT Filed: Nov. 10, 2010
(86) PCT No.: PCT/IB10/55111

§ 371 Date: Jul. 27, 2012

(30) Foreign Application Priority Data
Nov. 11, 2009 (IL) 202062

(51) Int. Cl. G01C 21/00

(52) U.S. Cl. 701/409

(57) ABSTRACT

A device, system and method for self orientation determining a current location, based on measurement of the location of at least one random landscape object, such as any type of landscape feature.

### FIELD OF THE INVENTION

The present invention relates to an apparatus, system and a method for self orientation, and in particular, to such an apparatus, system and method which permit the relative location of an object to be determined within an environment.

### BACKGROUND OF THE INVENTION

Currently available technologies for devices for determining position location are based on measuring, or calculating, the distance and also direction of the device, relative to a constant object or objects with a known location.

Early navigation systems that were used mainly to guide aviators, at low visibility conditions, for example during World War II, were based on the principal of radio triangulation. The moving object (plane) had a directional antenna that was connected to a compass scale. The aviator directed the antenna to the general direction of a land based radio transmitter, while its receiver was set to the frequency of that transmitter. When the transmitted signal was received, the aviator turned the antenna until the maximal signal intensity is measured. The azimuth was then marked and the plane's navigator drew a line aligned with the “back azimuth” direction on a map, which originated from the known location of the land based transmitter. The process was then repeated, with respect to a second land transmitter; the point of intersection of the two lines represented the plane's location.

More advanced navigation systems were developed when airborne radar systems were introduced. These systems were able to measure both distance and azimuth, thus enabling the plane to measure its location with respect to a known fixed object.

Today, radio triangulation systems are currently being employed in many cellular telephone networks, which determine the location of a cellular device, such as a cellular telephone, by measuring the intensity of its signal with respect to a number of cellular transmission stations with a known location.

Another method that was previously used more frequently is dead reckoning, which is the process of estimating present position by projecting course and speed from a known past position. The dead reckoning position is only an approximate position because it has cumulative errors (example: compass errors or any other external influences).

An inertial navigation system is a type of dead reckoning navigation. Inertial navigation systems, once highly common for aviation and marine vessels, are based on a three dimensional acceleration sensor. The system initial measuring point is calibrated before the vessel starts its journey, and the primary coordinate system of the sensor is aligned with the magnetic north direction. The system integrates the acceleration measured by the accelerometer, thus creating a 3 dimensional speed vector. A second integration will generate a 3 dimensional displacement vector. When adding the displacement vector to the initial location vector, the system is able to pinpoint the current location of the vessel.

A GPS (Global Positioning Satellite) system is a modern and more accurate technology which also uses the triangulation method. The GP Satellites are a group of communication satellites that are located in a synchronic trajectory around the earth, thus maintaining their relative position with respect to the earth's surface. Each satellite transmits a synchronized time signal, which is received by the GPS receiver. The GPS receive is also synchronized with the same clock system. Therefore, the GPS receiver can calculate the time gap between its own internal clock and the satellite's clock, thus calculating its distance from the known position of the satellite. Repeating that calculation for several satellites (typically at least 3) will enable the receiver to calculate its own location.

Navigators in off road terrain conditions often apply a combination of the above mentioned principles, while using relatively simple aids such as azimuth triangulation determined with respect to two known, prominent landscape features; or for example measuring the distance (with a distance measuring device such as for example LRF—Laser Range Finder or other range finder) and azimuth with respect to a single known, prominent landscape object, will enable the user to locate his/her current position.

Celestial observation—uses exact time, calendar date and angular measurements taken between a known visible celestial body (the sun, the moon, a planet or a star) and the visible horizon, usually using a sextant (see below sextant explanation at elevation measuring methods), At any given instant of time, any celestial body is located directly over only one specific geographic point, or position on the Earth. The precise location can be determined by referring to tables in the Nautical or Air Almanac for that exact second of time, and for that calendar year.

All the above mentioned technologies and methods are characterized by reliance upon an interaction between the target/navigation device and a fixed object with known location, which acts as an origin for location calculation.

### SUMMARY OF THE INVENTION

There is an unmet need for, and it would be highly useful to have, a system and a method for self orientation. There is also an unmet need for, and it would be highly useful to have, a system and a method for determine its own location in an autonomous manner, based on random measurement of the location of at least one random landscape object, such as any type of landscape feature.

The present invention, in at least some embodiments, overcomes these deficiencies of the background by providing a device, system and method for self orientation determining a current location, based on measurement of the location of at least one random landscape object, such as any type of landscape feature.

Optionally however the landscape object is selected according to a partially or completely directed process, and is not selected purely randomly. Optionally and preferably, in any case the position of the landscape object is not known at the time of selection.

According to at least some embodiments, there is provided a self position determining apparatus with a position detection method that detects the current location of the apparatus, to enable the user to determine a current location.

Optionally and preferably, the apparatus acts as a navigational aid, for assisting the user to move to a desired location within an environment and/or assisting the user to target a particular desired location. For example, optionally and more preferably, for targeting a location, the apparatus preferably is able to determine the location of any target within the viewing and measuring range of the apparatus.

As used herein, the term “landscape” is used to describe any type of environment, preferably an external environment (ie outside of a building). The term “landscape object” may optionally also refer to any type of landscape feature.

A “field” environment or landscape refers to an environment or landscape wherein a majority of features are natural and not manmade or artificial.

According to at least some embodiments of the present invention there is provided a method for self orientation of an object in a three dimensional environment, comprising: providing mapped data for at least a portion of the environment comprising digitized data relating to a plurality of points of said three dimensional environment; performing a plurality of linear measurements from said object to at least one other feature of the environment, wherein said plurality of linear measurements are performed along at least one clear line of sight between said object to said at least one other feature of the environment; and locating the object in relation to said at least one other feature of the environment according to said plurality of linear measurements, wherein said at least one other feature is locatable in said mapped data, wherein a position of said at least one other feature is not known before said performing said plurality of linear measurements and wherein said locating the object is performed by a computer.

Optionally, only such linear measurements are used, without reference to any other type of measurement.

By “linear measurement” it is meant any measurement of distance, elevation, or azimuth. It does not include GPS coordinates or inertial measurements.

Optionally the method further comprises randomly selecting said at least one other feature before performing said plurality of measurements.

Optionally said locating the object in relation to said at least one other feature only includes performing a plurality of linear measurements, without performing any other type of measurement and without GPS data or inertial data.

Optionally said performing said plurality of measurements comprises determining at least two of a distance between the object and said at least one other feature, the relative azimuth between them, or the relative height between them.

Optionally only one of height and distance, relative height and relative azimuth, or relative azimuth and distance are used.

Optionally distance, relative azimuth and relative height are used, and said performing said plurality of measurements is performed with a range finder, a compass, and a tilt measuring device.

Optionally said range finder is selected from the group consisting of an optical range finder, a laser range finder, an acoustic range finder and an electromagnetic range finder.

Optionally said line of sight is clear if any type of reflected electromagnetic radiation is transmissible between them.

Optionally said performing said plurality of measurements comprises determining a plurality of vectors expressing said orientation relationship between the object and said at least one other feature.

Optionally a number of said plurality of vectors is increased for an environment having fewer distinctive features.

Optionally said providing mapped data comprises digitizing data representative of the three dimensional surface of the environment; and describing each environmental feature in terms of a point on said surface.

Optionally said locating the object comprises transforming a relative location to a vector structure that conforms to the coordinate system of said mapped data.

Optionally said locating the object further comprises locating each point in said plurality of vectors that does not provide a description of a “True” point of said mapped data; and removing each vector that does not correspond to at least one “true” point of said mapped data.

Optionally if all vectors match a point of said mapped data, selecting said point as an optional solution to said locating the object.

Optionally if only one optional solution is found, selecting said optional solution as a location of the object.

Optionally if a plurality of optional solutions are found, calculating a line of sight for each vector, such that if said line of sight is not present between said at least one other feature of the environment and said optional solution, rejecting said optional solution as a false solution.

Optionally said calculating said line of sight comprises searching through a plurality of points and determining a plurality of vectors for said points; comparing z values of vectors to z values of said mapped data; and if z values of said mapped data which are on the path of a proposed view point line are greater than the z value of the linear line of the view point, then there is no viewpoint.

Optionally providing said mapped data comprises one or more of providing a matrix of mapped data, a table of mapped data, normalized mapped data, sorted mapped data or compressed mapped data, vector mapped data, DTM (digital terrain model) mapped data, DEM (digital elevation model) mapped data, DSM (digital surface model) mapped data or a combination thereof.

Optionally said locating the object comprises searching through a plurality of points.

Optionally said searching through said plurality of points comprises eliminating points having a distance greater than a range of a range finder.

Optionally said searching through said plurality of points comprises eliminating points having greater than a maximum height and less than a minimum height relative to a measured height.

Optionally said computer comprises a thin client in communication with a remote server and wherein said searching through said plurality of points is performed by said remote server.

Optionally said computer further comprises a display screen, the method further comprising displaying a result of locating the object on said display screen.

Optionally the environment comprises high feature terrain having at least 3 features per square kilometer and wherein said performing said plurality of linear measurements from said object comprises performing said plurality of linear measurements from said object to at least 1 feature.

Optionally the environment comprises low feature terrain having at least 1 feature but fewer than 2 features per square kilometer and wherein said performing said plurality of linear measurements from said object comprises performing said plurality of linear measurements from said object to at least 3 features.

Optionally the environment comprises medium feature terrain having at least 2 features but fewer than 3 features per square kilometer and wherein said performing said plurality of linear measurements from said object comprises performing said plurality of linear measurements from said object to at least 2 features.

Optionally the object is located at a location selected from at least one of air, ground or sea, and wherein the feature is located at a location selected from at least one of ground or sea.

Optionally said locating the object comprises performing an error correction on one or more of said measurements and/or said mapped data, and searching through said mapped data according to said plurality of measurements and said error correction.

Optionally said providing said mapped data comprises providing an initial error estimate for said mapped data; and wherein said performing said error correction is performed with said initial error estimate.

Optionally said performing said plurality of linear measurements comprises determining an initial measurement error; and wherein said performing said error correction is performed with said initial measurement error.

Optionally said environment comprises an urban environment or a field environment.

Optionally the method further comprises determining at least one clear line of sight between said object to said at least one other feature of the environment before said performing said plurality of measurements.

Optionally said determining said at least one clear line of sight comprising performing a line of sight algorithm for all points of said mapped data and storing results of said line of sight algorithm.

According to at least some embodiments of the present invention, there is provided a method for self orientation of an object in a three dimensional environment, comprising: providing mapped data for at least a portion of the environment comprising digitized data relating to a plurality of points of said three dimensional environment; performing a plurality of linear measurements from said object to at least one other feature of the environment, wherein said plurality of linear measurements are performed along at least one clear line of sight between said object to said at least one other feature of the environment; and locating the object in relation to said at least one other feature of the environment according to said plurality of linear measurements, wherein said at least one other feature is locatable in said mapped data, wherein a position of said at least one other feature is not known before said performing said plurality of linear measurements, wherein said locating the object is performed by a computer and with the proviso that said performing said plurality of measurements and/or said locating the object is not performed with an imaging device.

According to at least some other embodiments of the present invention, there is provided a method for self orientation of an object in a three dimensional environment, comprising: providing mapped data for at least a portion of the environment comprising digitized data relating to a plurality of points of said three dimensional environment; performing a plurality of linear measurements from said object to at least one other feature of the environment, wherein said plurality of linear measurements are performed along at least one clear line of sight between said object to said at least one other feature of the environment; and locating the object in relation to said at least one other feature of the environment according to said plurality of linear measurements, wherein said at least one other feature is locatable in said mapped data, wherein a position of said at least one other feature and a relative orientation between the object and said at least one other feature is not known before said performing said plurality of linear measurements, wherein said locating the object is performed by a computer.

According to at least some other embodiments of the present invention, there is provided an apparatus for performing the method according to any of the above claims, said apparatus comprising a plurality of measurement devices for determining an orientation relationship between the object and said at least one other feature of the environment; a display screen for displaying said orientation relationship; and a processor for performing a plurality of calculations for locating the object in said mapped data according to the method of the above claims in order to determine said orientation relationship.

Optionally said plurality of measurement devices comprises a distance measuring device; an azimuth measuring device; and an inclination measuring device.

Optionally said distance measuring device comprises a range finder.

Optionally said range finder is selected from the group consisting of an optical range finder, a laser range finder, an acoustic range finder and an electromagnetic range finder.

Optionally said azimuth measuring device comprises a compass with digital output.

Optionally said compass comprises a magnetic compass, a gyrocompass or a solid state compass.

Optionally said inclination measuring device comprises a tilt sensor with digital output.

Optionally the apparatus further comprises a memory device for storing said mapped data.

Optionally the apparatus further comprises a frame on which said measurement devices are mounted, such that said measurement devices are aligned and share a common reference point.

According to at least some other embodiments of the present invention, there is provided observation equipment comprising the apparatus as described herein.

According to at least some other embodiments of the present invention, there is provided a system comprising the apparatus as described herein, and a central server for performing calculations on said mapped data.

Without wishing to be limited, according to at least some embodiments of the present invention, a landscape feature may optionally comprise a building or other artificial structure. For example, in an urban landscape, optionally at least a portion of the landscape features comprise buildings. Preferably the buildings are at least 10 stories tall, more preferably at least 50 stories tall and most preferably at least 100 stories tall. Without limitation, it is understood that such an application could optionally be used in conjunction with GPS or other navigation systems, or instead of such navigation systems, for example if the GPS signal is blocked.

By “imaging device” it is meant a camera, CCD (charge coupled device) and/or radar.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” optionally on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, STB (Setup Box) server or a PVR (Personal Video Recorder), a video server, any micro processor and/or processing device, optionally but not limited to FPGA and DSPs. Any two or more of such devices in communication with each other, and/or any computer in communication with any other computer may optionally comprise a “computer network” and/or any micro processor and/or processing device, optionally but not limited to FPGA and DSPs.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-1C show a representation of a terrain in a digitized topographic map;

FIG. 1D shows a flowchart of an exemplary, non-limiting, illustrative method for orientation according to at least some embodiments of the present invention;

FIG. 2 shows an example of the process for stage 3 above, in which the square 206 represents the location of the user, relative to two separate landscape points, shown as circles 202 and 204;

FIG. 3 represents an exemplary, illustrative, non-limiting 3D view of an array of three measurements of an exemplary array of three vectors, representing the relationships between the observer's location and three exemplary landscape points;

FIG. 4A is a 3D representation of the vector search procedure, as described in stage 5 above, while FIG. 4B represents a top view, and FIG. 4C represents a side view, of the vector search procedure, as shown in FIG. 4A;

FIG. 5 is a 3D representation of the database after undergoing the vector search procedure, as described in stage 5 above;

FIG. 6 shows a non-limiting, illustrative example of a method for determining the coordinates of a target landscape point according to at least some embodiments of the present invention;

FIG. 7 shows an exemplary apparatus according to at least some embodiments of the present invention;

FIG. 8 shows an exemplary method for determining a line of sight according to at least some embodiments of the present invention;

FIG. 9 is a schematic block diagram of an exemplary system according to at least some embodiments of the present invention;

FIG. 10 shows a flowchart of an exemplary method according to at least some embodiments of the present invention;

FIG. 11 relates to the outcome of the use of interpolations with any of the above methods according to at least some embodiments of the present invention;

FIG. 12 shows digitized map data;

FIG. 13A represents a top view visualization of the relative location vector between the selected observation point and the random landscape point, while FIG. 13B represents a zoomed and tilted view of the relative location vector between the selected observation point and the random landscape point;

FIG. 14A represents a top view of the search process, while the original vector is presented for the sake of clarity only; and FIG. 14B represents a zoomed and tilted view of the search process, near the original observer's location, while the original vector is presented for the sake of clarity only;

FIG. 14C shows that the last iteration shows that the vector and the map database may match at a specific coordination on map;

FIG. 15 represents a top view of the search process, after all the points in data base have been scanned;

FIG. 16 shows the measured vector which is compliant to points I the database; and

FIGS. 17A-17C show an overall view of measurement of a surface area.

### DESCRIPTION OF THE PREFERRED EMBODIMENTS

The present invention, in at least some embodiments, is of an apparatus, system and method for self orientation determining a current location, based on measurement of the location of at least one landscape object, such as any type of landscape feature, which may optionally be is selected randomly and/or in a completely or partially directed manner. Optionally and preferably, in any case the position of the landscape object is not known at the time of selection.

Without wishing to be limited by a single hypothesis, preferred embodiments of the present invention rely on the principle of the singularity of landscape objects and the singularity of their data representation in a topographic map. Hence, the relationship between the locations of two landscape objects, described herein as “landscape points”, is defined by a set of numbers representing the relative orientation of the two landscape points, which may optionally be expressed in terms of any coordinate system, such as an XYZ coordinate system for example. As a non-limiting example, if an XYZ orthogonal linear system is used, the relationship may optionally be expressed according to the vector on the distance between the two points, the relative azimuth between them, the relative height between them and the presence of a clear line of sight between them. If this vector can be so defined, then a vector array for any random point in the landscape, with respect to a plurality of other points in the landscape, is singular, such that no other landscape point will have similar relationships of distance, azimuth, elevation and line of sight with regard to the surrounding landscape. By “random” it is meant that the initial position of the point is not known.

The strength of the above statement increases as the number of vectors in the array increases and/or when the measurement resolution and accuracy increases, and/or as the total landscape area being considered is reduced in size.

However if the terrain of the landscape is less distinctive, i.e. has fewer distinctive features, different points in the landscape are more likely to be appear to be similar; preferably an increased number of vectors are employed to distinguish between such points. Non-limiting examples of such less distinctive terrain includes plateaus and/or sand dunes and/or large plains, or even urban environments with reduced variability of building heights, sizes and/or other building features and/or other urban landscape features.

The principles and operation of the present invention may be better understood with reference to the drawings and the accompanying description.

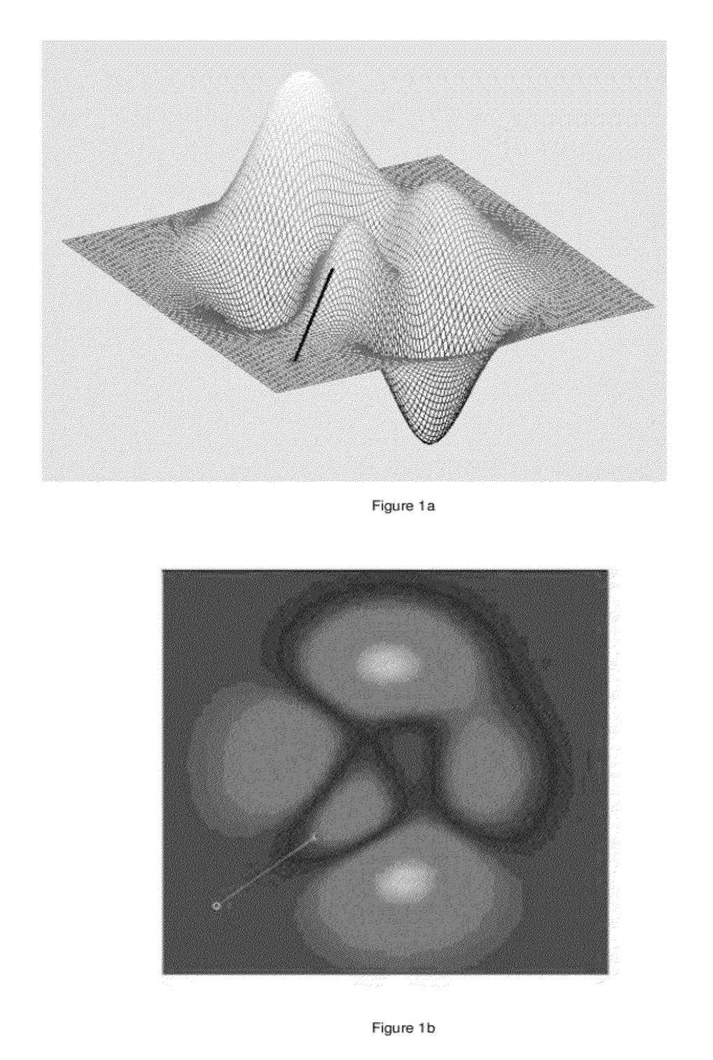

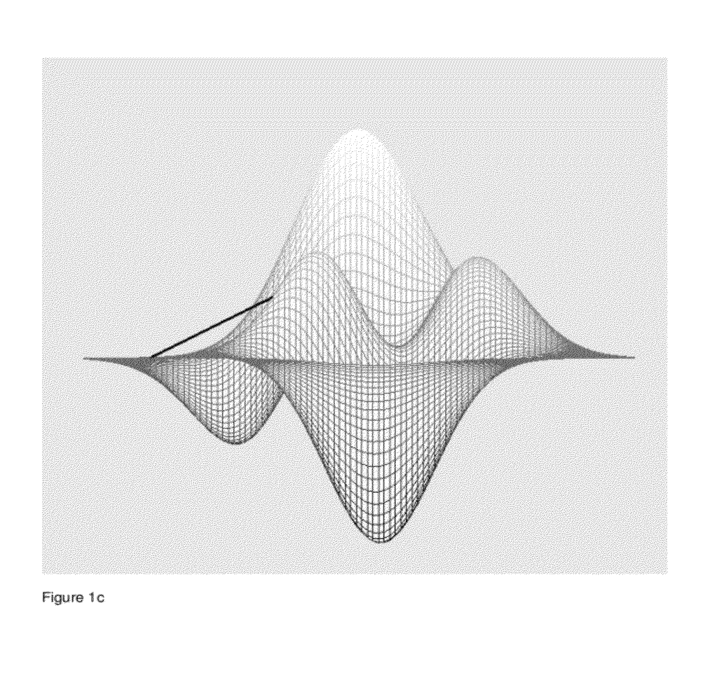

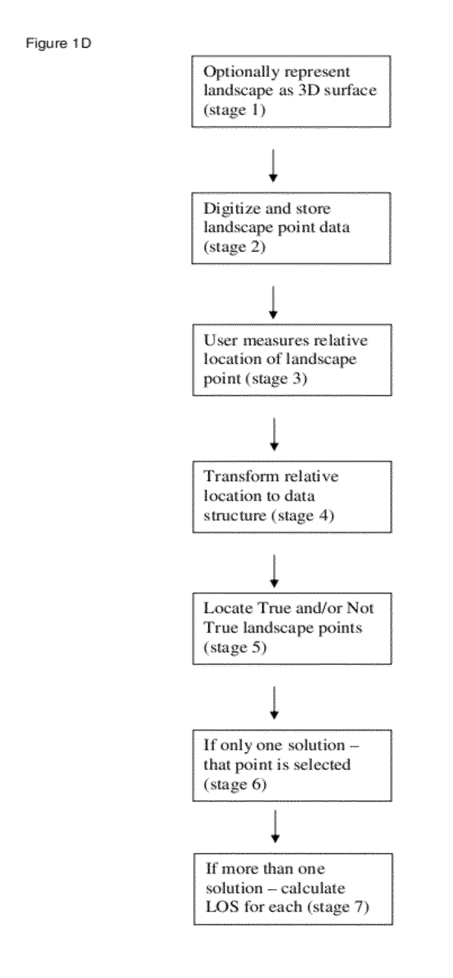

Referring now to the drawings, FIGS. 1A-1C show a representation of a terrain in a digitized topographic map, in which the landscape is represented as a 3D (three dimensional) surface in which any point is described by three linear coordinates: coordinates X and Y represent the surface location in any known coordinate system, while Z represents the height above sea level. FIG. 1D shows a flowchart of an exemplary, non-limiting, illustrative method for orientation according to at least some embodiments of the present invention.

FIG. 1A represents a 3D view of a vector representing the relationship between two landscape points. FIG. 1B represents a top view of a vector representing the relationship between 2 landscape points. This way of representation is similar to the representation in a topographic map. FIG. 1C represents a side view of a vector representing the relationship between 2 landscape points.

Based on the above described principles and the singularity of a vector array of any landscape point, it is clear that an opposite process could also optionally be employed, such that the coordinates of a landscape point could also optionally be calculated based on data derived from its vector array (and optionally and preferably based only upon such data).

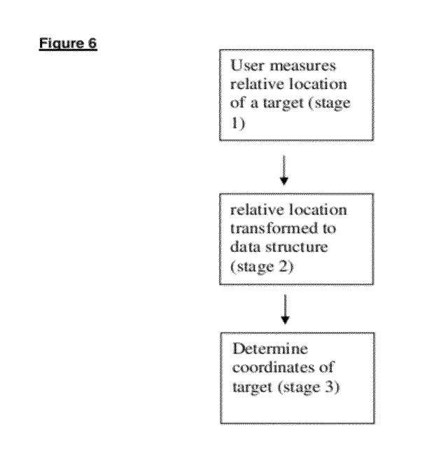

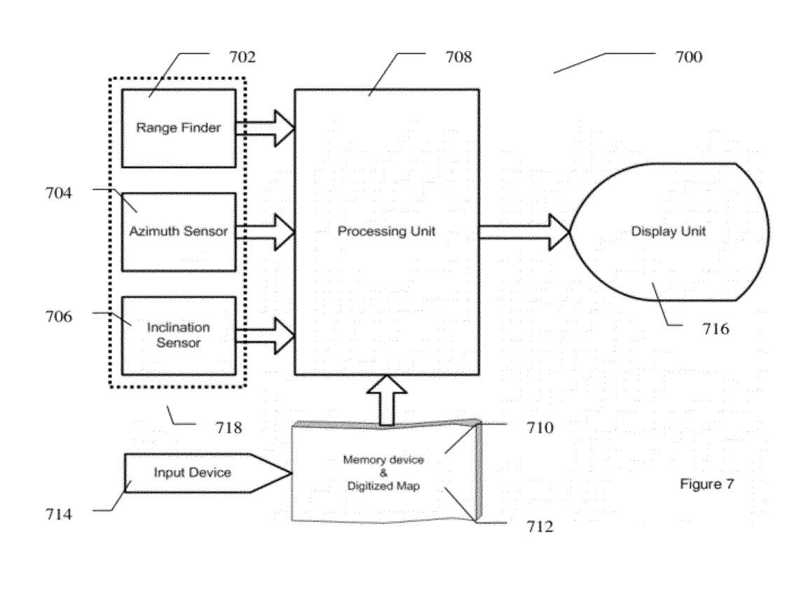

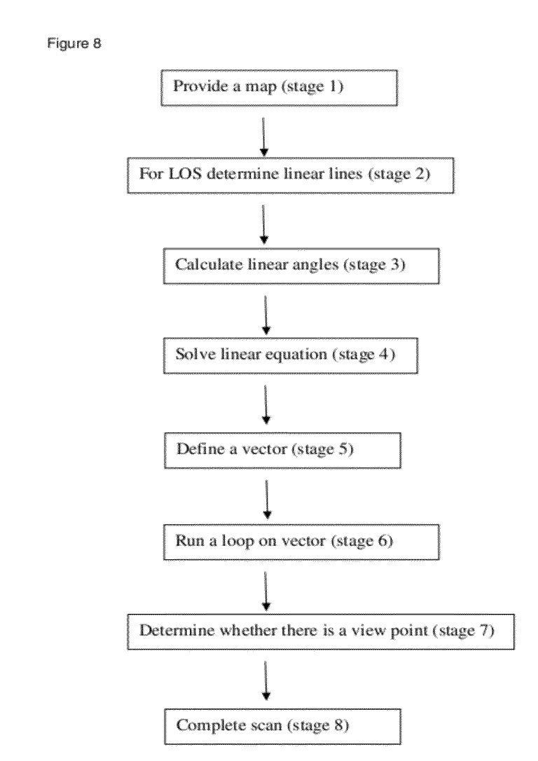

When an observer is located at an unknown point, the coordinates of his/her position could be found while using the following exemplary, illustrative coordinate search procedure according to at least some embodiments of the present invention (see also FIG. 8 for a more detailed description of an exemplary method for position determination), given as the below stages (shown in FIG. 1D):
1. In stage 1, the landscape of the area under consideration is optionally is represented as a three dimensional surface in any type of coordinate system (Linear, Cylindrical, Spherical etc.), having a plurality of landscape points.
2. In stage 2, the data regarding the landscape points in the coordinate system is digitized and stored in a memory device as a data base in which any point on the surface is described by a set of coordinates. Optionally, stage 2 is performed directly, in which case various measurements required to represent the landscape points are performed but without first representing the landscape as a three dimensional surface. As described in greater detail below, the digitized points are optionally provided through a DEM (digital elevation model) or a DSM (digital surface model) as described in greater detail below with regard to FIG. 7; optionally the system of FIG. 7 may be used for implementing the method of FIG. 1D.
3. In stage 3, the user measures the relative location of a landscape point that is visible from his/her present location. By “visible” it is meant according to any type of reflected electromagnetic radiation, including but not limited to any type of light, such as for example (and without limitation) light in the visible spectrum. As previously described, the landscape point may optionally be randomly selected, or selected through partially or completely directed selection. Optionally and preferably, in any case the position of the landscape object is not known at the time of selection.

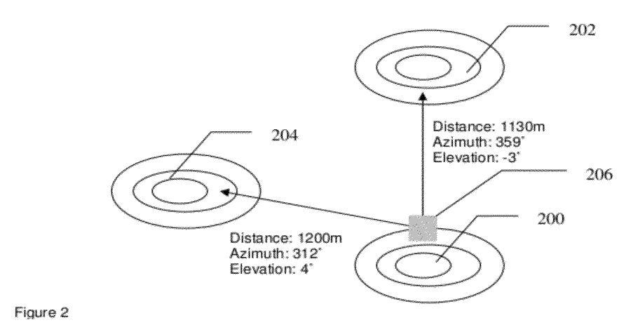

FIG. 2 shows an example of the process for stage 3 above, in which the central circle 200 represents a peak near, but not necessarily at, the location of the user 206, relative to two separate landscape points, shown as circles 202 and 204, which are representative of locations on a topographical map. The user measures the relative location of circles 202 and 204 with regard to the current position of the user 206. As shown, the relative position of the user's location 206 to circle 202 is as follows: Distance: 1130 m; Azimuth: 359°; Elevation: 31 3°. The relative position of the user's location 206 to circle 204 is as follows: Distance: 1200 m, Azimuth: 312° and Elevation: 4°. The user preferably measures all three relative location values (in this non-limiting example distance, azimuth and elevation) although optionally only two such location values are measured. As described in greater detail below, different location values may also optionally be measured. Various exemplary measuring devices are described in greater detail below which support the measurement of such location values.
4. In stage 4, the relative location (as described with regard to the above location values) is transformed to a data structure that conforms to the coordinate system of the landscape (or rather, of the map of the landscape). Optionally and preferably, such a data structure comprises a vector structure although other types of data structures may also optionally be used as described in greater detail below.
5. In stage 5, search algorithm scans the above mentioned database and locates those points in which the data structure provides and/or does not provide a description of a “True” landscape point. The definition of a “True” point depends upon the algorithm and data structure used, but generally involves finding a match (whether exact or sufficiently close) between the relative location values and the coordinates of the landscape points. Optionally both “True” and “Not True” points are located; for example, optionally “Not True” points are located first and eliminated from further consideration.
As a non-limiting example, if the data structure comprises a vector array, the verification is optionally performed according to the following vector equation, featuring vector addition:

(Pₘ₁, Pₘ₂, Pₘ₃)+(C₁₁, C₁₂, C₁₃)=(Sₘ₁₁, Sₘ₁₂, Sₘ₁₃)

(Pₘ₁, Pₘ₂, Pₘ₃)+(C₁₁, C₁₂, C₁₃)=(Sₘ₁₁, Sₘ₁₂, Sₘ₁₃)

to.

(Pₘ₁, Pₘ₂, Pₘ₃)+(Cₙ₁, Cₙ₂, Cₙ₃)=(Sₘₙ₁, Sₘₙ₂, Sₘₙ₃)
Where:
Pₘ₁ to Pₘ₃ are the coordinates of the point m under question.
Cₙ₁ to Cₙ₃ are the coordinates of vector n in the vector array that is the singular representation of the observer's location.
Sₙ₁ to Sₙ₃ is the sum of the addition of the vector of the point under question and the coordinates of vector n in the vector array that is the singular representation of the observer's location.
   The database is preferably then scanned and the vectors (Sₘ₁₁, Sₘ₁₂, S₁₃) to (Sₘₙ₁, Sₘₙ₂, Sₘₙ₃) produced above are compared to vectors in the data base.
   If at least one of the vectors (Sₘ₁₁, Sₘ₁₂, S₁₃) to (Sₘₙ₁, Sₘₙ₂, Sₘₙ₃) does not match any point in the database, this point is preferably then cleared from further consideration as not conforming to the observer's location.
   If all vectors (Sₘ₁₁, Sₘ₁₂, S₁₃) to (Sₘₙ₁, Sₘₙ₂, Sₘₙ₃) match a specific point in the data base, this point is preferably marked as an optional solution to the location of the observer.
   This method could clearly be extended by one of ordinary skill in the art to other types of data structures.
6. In stage 6, if only one such solution is located, then this point represents the coordinates of the observer's location.
7. In stage 7, if more than one solution is found, for each point m that was marked as an optional solution, preferably a “Line of Sight” is calculated for each vector (Sₘ₁₁, Sₘ₁₂, S₁₃) to (Sₘₙ₁, Sₘₙ₂, Sₘₙ₃) or other data structure, based on any algorithm as is known in the art. For example FIG. 8 and the accompanying description relate to an example of an illustrative algorithm for determining “Line of Sight” according to at least some embodiments of the present invention. Other non-limiting examples of algorithms for determining Line of Sight (LOS) are described in U.S. Pat. No. 4,823,170, issued on Apr. 18, 1989 and in U.S. Pat. No. 6,678,259, issued on Jan. 13, 2004. The paper “Fast Line-of-Sight Computations in Complex Environments” by Tuft et al, provided in a technical report by Univ. of North Carolina at Chapel Hill and available on the internet as of Nov. 5, 2010, describes determining LOS for a set of points contained within a computer system. This calculation is preferably used to detect false solutions, in which there is no Line of Sight between the point under consideration (Pₘ₁, Pₘ₂, Pₘ₃) and at least one of the target points (Sₘₙ₁, Sₘₙ₂, Sₘₙ₃).
8. After checking LOS, if one solution is found then the process stops. Otherwise in stage 8, another vector is preferably checked.

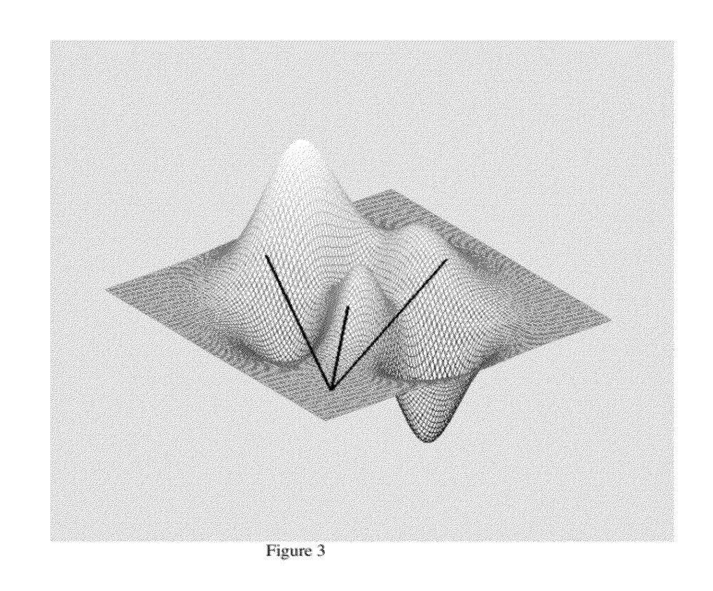

FIG. 3 represents an exemplary, illustrative, non-limiting 3D view of an array of three measurements of an exemplary array of three vectors, representing the relationships between the observer's location and three exemplary landscape points.

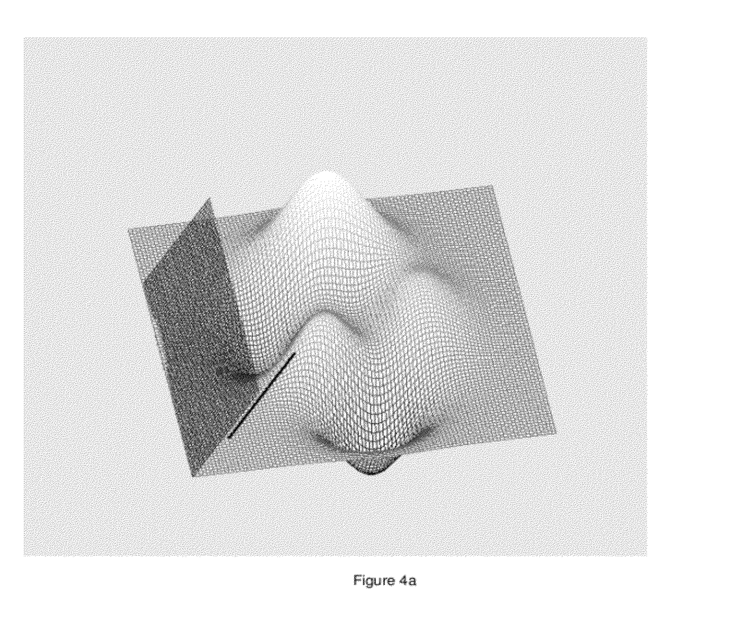

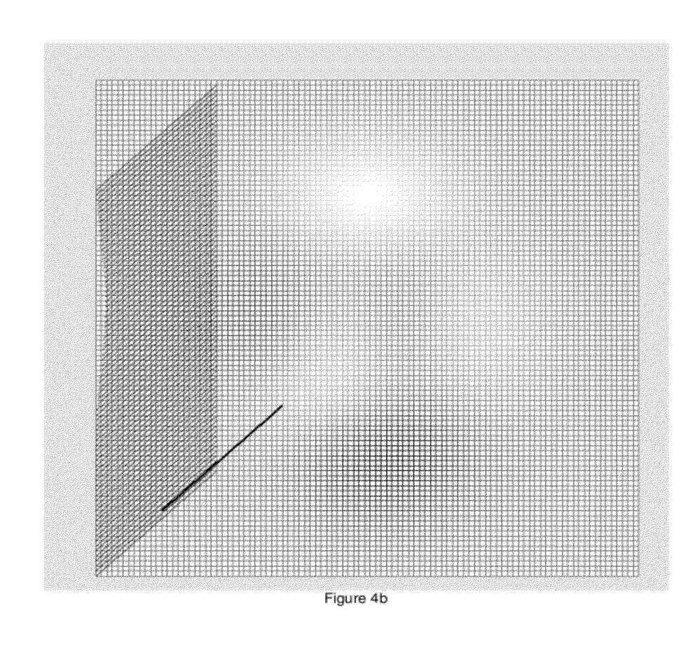

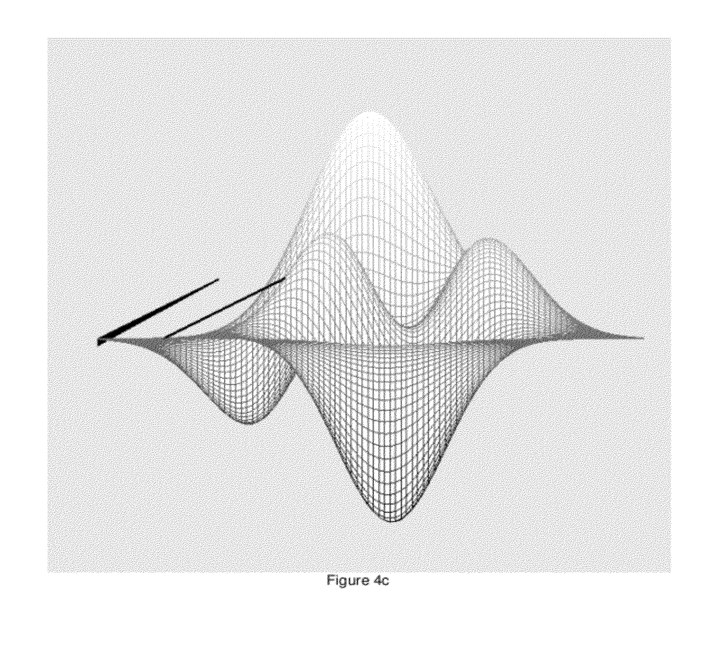

FIG. 4A is a 3D representation of the vector search procedure, as described in stage 5 above. FIG. 4B represents a top view, and FIG. 4C represents a side view, of the vector search procedure, as shown in FIG. 4A. FIG. 5 is a 3D representation of the database after undergoing the vector search procedure, as described in stage 5 above.

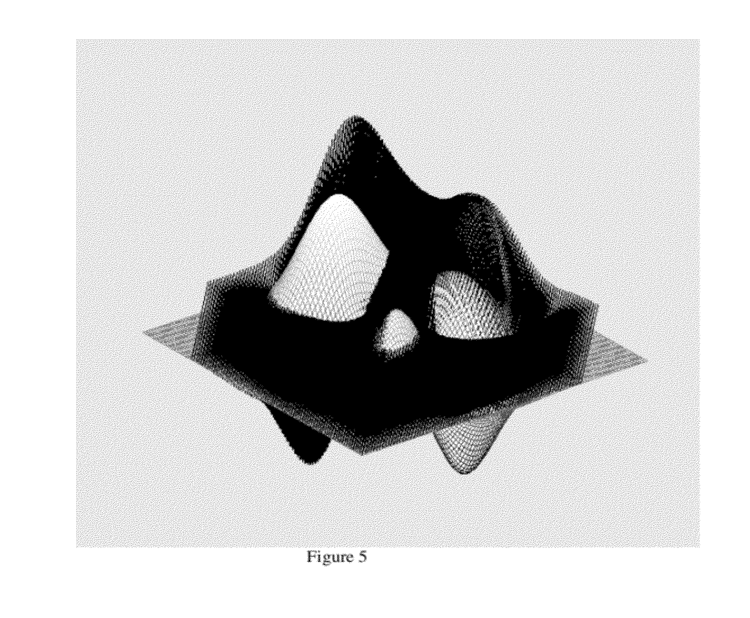

According to at least some exemplary, illustrative embodiments of the present invention, once the observer's location is determined, the coordinates of any target within the observer's line of sight and measuring distance may also optionally and preferably be determined. Optionally and more preferably, the coordinates of the target are determined according to the following non-limiting, illustrative example of a method for determining the coordinates of a target landscape point according to at least some embodiments of the present invention, as shown in FIG. 6.
1. In stage 1, the user (observer) measures the relative location of a target, with respect to the user's present location.
2. In stage 2, the relative location is transformed to a data structure that conforms to the landscape coordinate system. For this non-limiting example, the data structure is assumed to be a vector structure.
3. In stage 3, the coordinates of the target are then optionally and preferably determined by the following vector equation:

(P₁, P₂, P₃)+(C₁, C₂, C₃)=(T₁, T₂, T₃)
Where:
P₁ to P₃ are the coordinates of the observation point.
C₁ to C₃ are the coordinates of vector of the relative location of the target, with respect to the observation point.
T₁ to T₃ is the outcome of the addition of the vector of the observation point and the coordinates of relative location of the target, and hence the coordinates of the target.

These coordinates may optionally then be used with the method of FIG. 1D, for example, for orienting the user. Such a method may optionally be performed after the method of FIG. 1D, for example, in order to determine the coordinates of the target.

FIG. 7 shows an exemplary apparatus according to at least some embodiments of the present invention. An apparatus 700 optionally and preferably features a distance measuring device 702, preferably a range finder such as a Laser Range Finder, an acoustic range finder or another suitable range finder for example; an azimuth measuring device 704, preferably a compass with digital output, although any angle sensor, preferably equipped with a digital output, may also optionally be used; and an inclination (or tilt) measuring device 706, preferably a tilt sensor with digital output. These components are preferably in communication with a processing unit 708, which receives input from these components. Processing unit 708 preferably also receives information from a memory device 710, which more preferably features for example a digital map 712 of the area under consideration. Processing unit 708 may also optionally receive input from an input device 714, such as a USB linked device for example.

Digital map 712 may optionally be prepared as follows. A digital elevation model (DEM) is a digital representation of ground surface topography or terrain. It is also widely known as a digital terrain model (DTM). A DEM can be represented as a raster (a grid of squares, also known as a heightmap when representing elevation) or as a triangular irregular network. DEMs are commonly built using remote sensing techniques, but they may also be built from land surveying. DEMs are used often in geographic information systems, and are the most common basis for digitally-produced relief maps.

U.S. Pat. No. 6,985,903, issued on Jan. 10, 2006, describes a system and method for storage and fast retrieval of a digital terrain model, which includes compressing a DEM, and hence which describes DEM mapped data. U.S. Pat. No. 7,191,066, issued on Mar. 13, 2007, describes a method for processing a digital elevation model (DEM) including data for a plurality of objects, for example for distinguishing foliage from buildings in an urban landscape, which also includes a description of building a DEM; this patent is hereby incorporated by reference as if fully set forth herein with regard to FIGS. 1 and 2, and the accompanying description.

A digital surface model (DSM) on the other hand may optionally include buildings, vegetation, and roads, as well as natural terrain features in the mapped data. A DSM is preferred for embodiments involving an urban landscape as previously described. The DEM provides a so-called bare-earth model, devoid of landscape features, while a DSM may be useful for landscape modeling, city modeling and visualization applications.

U.S. Published Application No. 2009/0304236, published on Dec. 10, 2009, describes a method of deriving a digital terrain model from a digital surface model of an area of interest, and is hereby incorporated by reference as if fully set forth herein with regard to FIGS. 1 and 2, and the accompanying description.

Optionally, whether data points from a DEM and/or a DSM are used, these points are divided into soft features and hard features. “Soft features” are those landscape features for which there is a reasonable expectation of change within a time period comprising one day, one week, one month, one year, five years, ten years or any time period in between. Non-limiting examples of soft features include trees and other vegetation; billboards and other signs; temporary structures; and the like.

Hard features are those landscape features for which there is not a reasonable expectation of change within a time period comprising one day, one week, one month, one year, five years, ten years or any time period in between. Non-limiting examples of hard features include mountains, hills, other elevated points in the land itself, canyons, caves and other depressed areas in the land itself, buildings, bridges, elevated roads, elevated road interchanges and exchanges, and so forth.

The digital map may therefore comprise a DEM and/or a DSM. The digital map may optionally be saved, for example, as a table of data.

For example, for such a table, the digital map comprises a plurality of points that provide a digital representation (a raster) of the ground surface topography, usually (but not necessarily) presented as a three dimensional matrix (for example, X, Y and Z coordinates). For the non-limiting of X, Y, Z coordinates, the X, Y points can be referenced for example to longitude (angular distance from the prime meridian) and latitude (determined by a circle of latitude).

The table preferably comprises three data elements for each point on the map: X, Y and Z (height) coordinates for this example (optionally as previously described, the table may only feature two data elements for each point). The table does not need to hold this data as a matrix, although this is possible.

Among the many advantages of a table and without limitation, is that the data contained in a table may optionally be sorted, after which the search algorithm is more efficient.

The data may also optionally be provided as a collection of points, not a table, in any coordinate system.

In any case, preferably one of the data elements is height or elevation of each target point (or potential target point) relative to the observational position of the user (if height is provided in absolute coordinates, then the data element of “height” is preferably determined relative to the position (location) of the user and/or according to a normalized map, in which all elevation values are normalized).

An algorithm as described herein for orienting the user could optionally use data from such a table as follows. If the following vector is to be searched: azimuth 100 deg, tilt 20 deg and length 1000 meters, then when this vector is searched in the table, the table may optionally be sorted with descending lengths from each point. By using the table the algorithm can directly access the relevant positions which apply to vectors with length of 1000. It is then possible to only search within the set of points having the 1000 meter length. It is optionally also possible to sort azimuth and/or tilt, or a combination of these data elements, and to search accordingly. It is also possible to use a hash algorithm to first retrieve a specific set of points and then to search within that set.

For any of the embodiments described herein, it is optionally possible to add to substitute a vector map for a collection of points, in which the vector map features points and vectors. In some situations, such a vector map may optionally be more efficient. A non-limiting example of a vector map is a VMAP or Vector Smart Map. Data are structured according to the Vector Product Format (VPF), in compliance with standards MIL-V-89039 and MIL-STD 2407, which are Military Standards of the US Department of Defense.

The calculations are preferably performed by processing unit 708 as described herein; the output is then preferably displayed on a display unit 716. The display unit 716 may optionally comprise a simple alpha-numeric display that displays the processing outcome as numeric coordinates, and/or may optionally feature a map display based on any known technology.

Optionally and more preferably, apparatus 700 also features a frame 718 on which all the above mentioned measuring devices and/or sensors are mounted, such that preferably they are all aligned and share a common reference point.

According to some embodiments of the present invention, the above mentioned components may optionally be implemented in observation equipment, such as binoculars and/or night vision devices, for example and without limitation. Also according to some embodiments of the present invention, the above mentioned components may optionally be implemented combined with any of the already existing prior arts aimed for navigation and/or position location, to increase accuracy, for example in less distinctive terrain, and/or to reduce the amount of measurements and shorten processing time.

As described above, azimuth measuring device 704 may optionally comprise a compass with digital output. Non-limiting examples of suitable compasses include:

Modern compasses—a magnetized needle or dial inside a capsule completely filled with fluid, consists of a magnetized pointer (usually marked on the North end) free to align itself with Earth's magnetic field.

Gyrocompass—can find true north by using an electrically powered, fast-spinning gyroscope wheel and frictional or other forces in order to exploit basic physical laws and the rotation of the Earth

Solid state compasses—usually built out of two or three magnetic field sensors that provide data for a microprocessor. The correct heading relative to the compass is calculated using trigonometry.

Inclination measuring device 706 may optionally comprise an elevation measurement device. Suitable non-limiting examples of such devices include:

Sextant:

A sextant is an instrument used to measure the angle between any two is visible objects. Its primary use is to determine the angle between a celestial object and the horizon which is known as the altitude

Tilt sensor:

A tilt sensor can measure the tilting in often two axes of a reference plane in two axes, Tilt sensors are used for the measurement of angles, typically in reference to gravity.

Common sensor technologies for tilt sensors and inclinometers are accelerometer, Liquid Capacitive, electrolytic, gas bubble in liquid, and pendulum.

FIG. 8 shows an exemplary method for determining a line of sight according to at least some embodiments of the present invention. The line of sight data (LOS) is preferably calculated by using a map database. The Line-Of-Sight is an imaginary straight line joining the observer with the object viewed.

LOS could optionally be defined for every point in the database and could also optionally be saved as a local search database. Such predefinition could optionally shorten the calculation time of the position location algorithm, by scanning only the local search database for every point under consideration.

In addition and in order to save calculations, it is possible to calculate LOS only to points within the range finder operational range, if such a device is used.

Regardless of the method used, it is possible to more efficiently calculate LOS, for example by using data structures, which is a particular way of storing and organizing data, for example by pre-arranging the data (our digital map) according to the algorithm needs. Examples of known data structures algorithms which are useful for calculating LOS include but are not limited to the R-Tree method, R*Tree method.

The method described in FIG. 8 is preferably used to verify a Line of Sight between a point and a target, shown as the below stages:
1. A “map” is provided as a database of points.
“Point1” is the view point, where Point1=[point1.x, point1.y, point1.z]; and “Point2” is the target, where Point2=[point2.x, point2.y, point2.z].
2. For a LOS at the X-Y surface, a linear line Y=ax+b is determined; and for the X-Z surface, a linear line Z=cx+d is also determined.
3. Calculate linear angle for X-Y surface: a=(point1.y−point2.y)/(point1.x−point2.x)
Calculate linear angle for X-Z surface: c−(point1.z−point2.z)/(point1.x−point2.x)
4. From linear equation: b=point1.y−a*point1.x & d=point1.z−c*point1.x
5. Define a vector built from point1.x Up to point2.x x_vec=[point1x:1:point2.x]
6. Run a loop on the x vector:

for index=1:length(x_vec)

x1=x_vec(index);
In the loop, for each x_vec point, build 2 z vectors:
   a. A vector comprising the z values of the map along the path of the viewpoint line, as described in the map database:

z_in_map_for_lineview(index)=map((a*x1+b),x1)
b. z values along the linear viewpoint line:

z_lineview(index)=c*x1+d
7. If z values on the map which are on the path of view point line are greater than the z value of the linear line of the view point—there is no viewpoint.
if z_in_map_for_lineview(index)>
z_lineview(index)
is_viewpoint=0;
end
end the loop.
8. The method preferably finishes when all, or at least a significant number of points, have been considered.

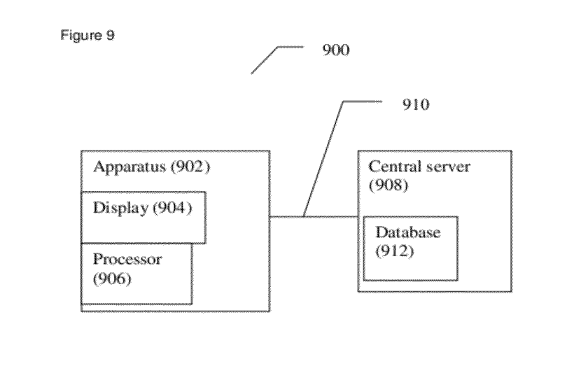

FIG. 9 is a schematic block diagram of an exemplary system according to at least some embodiments of the present invention. FIG. 9 shows a system 900 according to the present invention. A system 900 preferably features an apparatus 902, which may for example optionally be implemented as the apparatus of FIG. 7. However, optionally apparatus 902 provides a “thin client”, including a display 904 and a processor 906, but in which calculations are performed largely or completely by a separate server 908. Even if apparatus 902 is implemented as the apparatus of FIG. 6, optionally server 908 provides at least some information and/or processing support.

Apparatus 902 and server 908 optionally and preferably communicate according to any type of wireless communication network 910, such as for example a cellular or radio network. Apparatus 902 preferably reports a current location and/or calculation of a target location to server 908. Server 908 may optionally store such reported information and/or any information to be sent to apparatus 902 in a database 912.

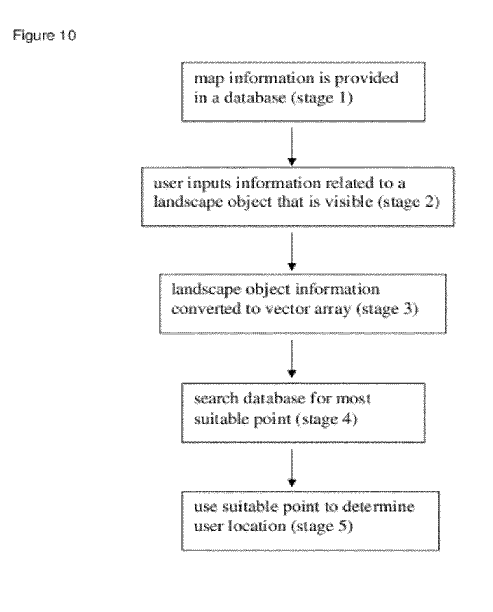

FIG. 10 is a flowchart of an exemplary method according to at least some embodiments of the present invention. As shown, in stage 1, map information is provided in a database, for example as described above. In stage 2, the user inputs information related to a landscape object that is visible, to an apparatus as described with regard to FIG. 8 (and/or they are automatically determined by the apparatus). For example, preferably distance, inclination and azimuth are measured in relation to the landscape object. In stage 3, the landscape object information is preferably converted to a vector array. In stage 4, a search is preferably performed as described herein to locate the most suitable point in the database in relation to the landscape object location information. In stage 5, once such a suitable point is found, then it may be used to determine the location of the user.

The above method may optionally also be used for determining a measurement from a moving observation point, if the transformation vector between each measurement point is known. This situation may also optionally feature a special error factor calculation as described below.

According to at least some embodiments of the present invention, not all data and/or instruments are available. For example, as previously described, optionally only two data elements for each landscape point are available for calculations. For example, if length and tilt (inclination) or tilt and azimuth are available, then a vector may optionally be created with these two data elements. It is also possible to solve equations with only azimuth and tilt, without using a vector data structure.

If there is no compass, such that a relative reading to the north or any other specific direction is not available, it is possible to instead measure the relative horizontal angle between the vectors, the combination of which is unique to find the user's position.

In order to compensate for the lack of relation to the north, it is preferred to rotate (up to 360 degrees) the vectors in the digital map until a compliant vector is located. The rotation will be to all vectors together in order to keep their relative horizontal angle between themselves.

If there is no tilt (elevation) measurement, for example a tilt (elevation) measurement relative to horizon or gravity, it is possible to compensate for this lack of information by performing the above procedure as mentioned to the horizontal vectors, but now using the tilt angles.

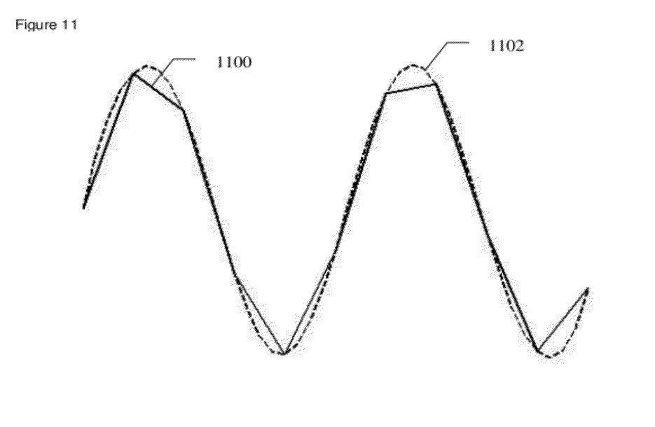

FIG. 11 relates to the outcome of the use of interpolations with any of the above methods according to at least some embodiments of the present invention, for example to overcome low map resolution. Interpolation of the available data preferably involves constructing a function which closely fits the map data points. This method will refine the low resolution map and will provide a more accurate solution. In FIG. 11, the dashed line 1102 is the interpolated line, while the solid line 1100 shows the actual original line. For this example, the “cubic spline” interpolation method was used but of course there are many different methods to interpolate.

### EXAMPLES

The following non-limiting examples relate to some illustrative, non-limiting applications of the above described embodiments of the present invention.

### Case Study—Jerusalem Mountains:

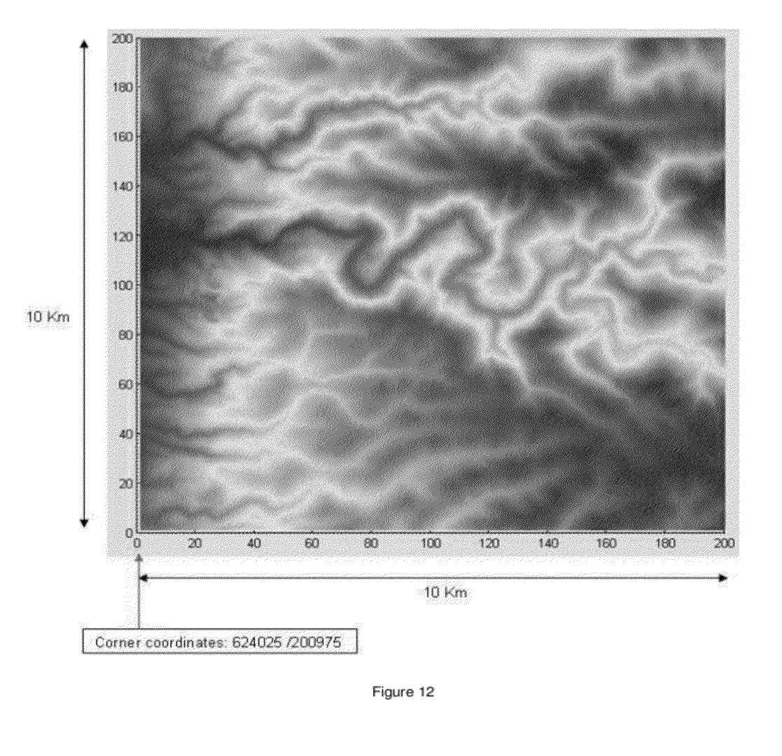

1. Digitized Map Data (shown in FIG. 12):
X (Eastern) coordinate left lower corner: 200975
Y (Northern) coordinate left lower corner: 624025
X Resolution: (Cell size) 50 meter
Y Resolution: (Cell size) 50 meter
Z (height) Resolution: 2 meter
Total number of rows: 200
Total number of columns: 200

2. Simulation with actual field coordinates—Jerusalem Mountains Digitized Map.
a. User measures the relative location of a random and visible landscape point, such that before such a measurement, the position of the landscape point is not known.

FIG. 13A represents a top view visualization of the relative location is vector between the selected observation point and the random landscape point.

FIG. 13B represents a zoomed and tilted view of the relative location vector between the selected observation point and the random landscape point.
b. Calculating solution:
The system scans the digitized map data base and searches for the vector which complies with the surface.

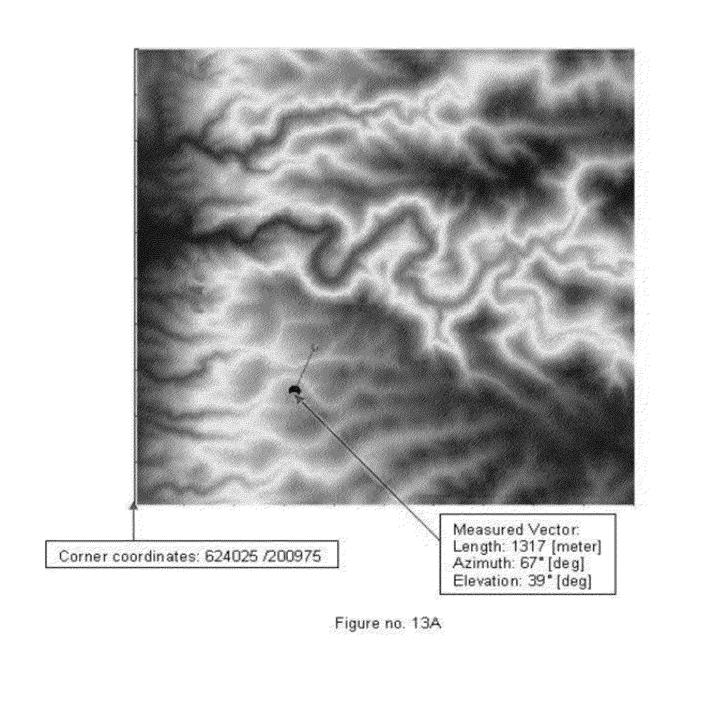

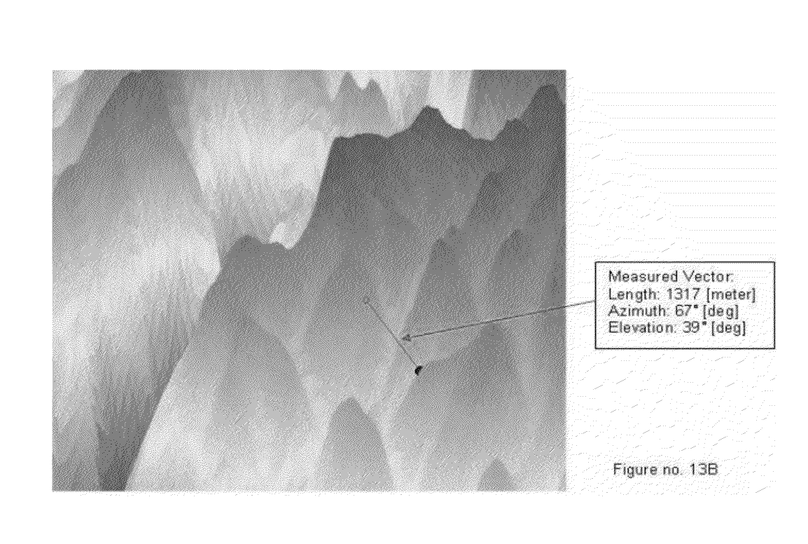

FIG. 14A represents a zoomed and tilted view of the search process, while the original vector is presented for the sake of clarity only.

FIG. 14B represents a zoomed and tilted view of the search process, near the original observer's location, while the original vector is presented for the sake of clarity only. In both cases the original vector is shown as a line starting from a dot.
c. Finding Compliance:

As shown in FIG. 14C, the last iteration shows that the vector and the map database may match at a specific coordination on map. The arrow (starting with a dot) specifies the location on which the vector which complies with the map's database.

The coordinate where the vector connects two points of the digitized data base is:
Eastern: 204175
Northern: 626575

This point is marked as an optional solution as previously described, while the process preferably continues scanning the database.

If the above solution is found to be a singular solution, it is preferably presented as the observer's location.

If ambiguity is found, as several optional solutions were located, the preferably the method recalculates the solution based on one or more additional vectors.

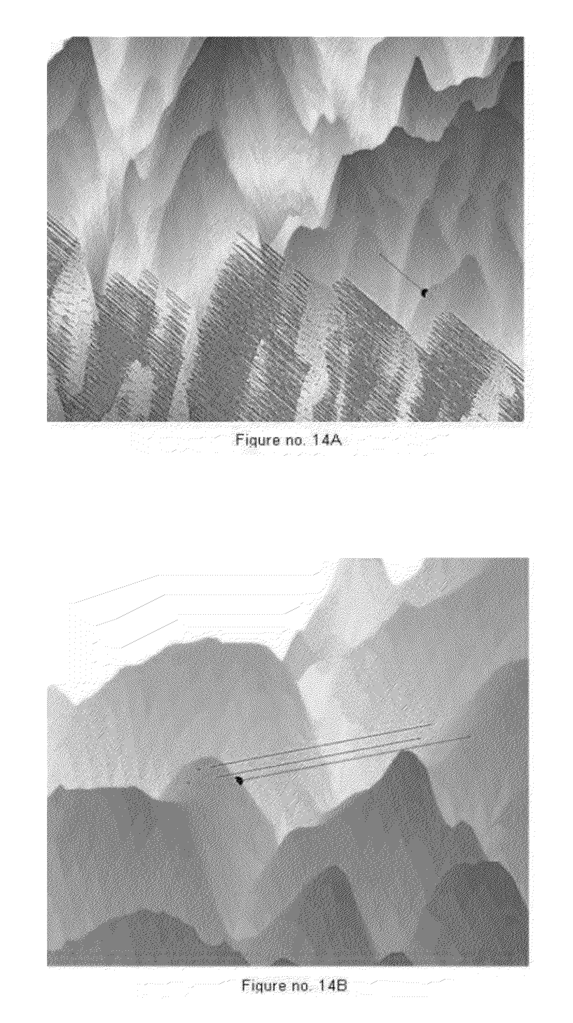

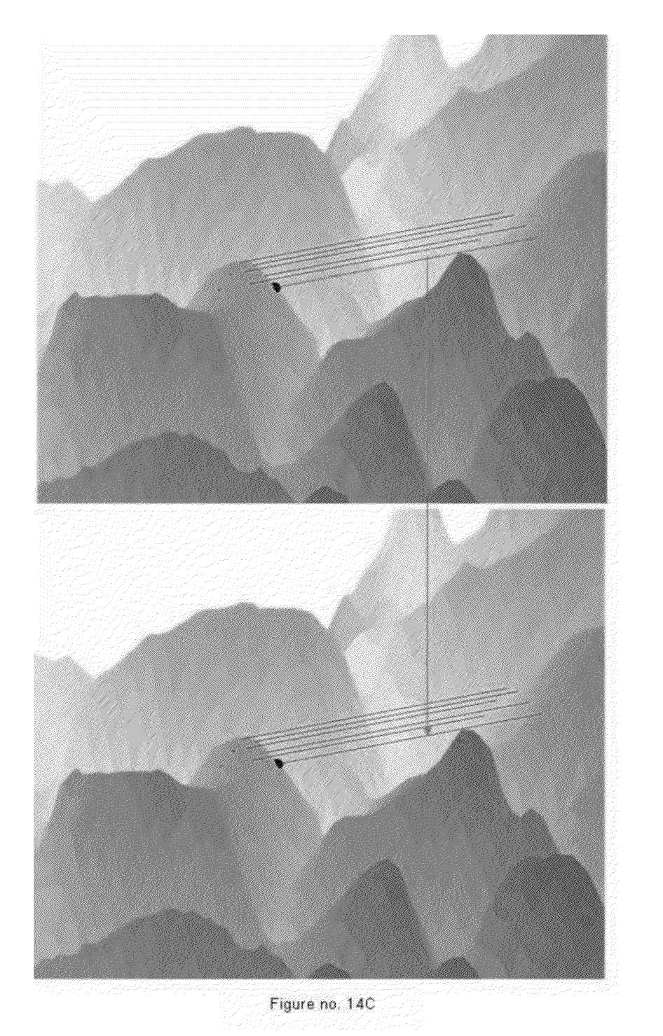

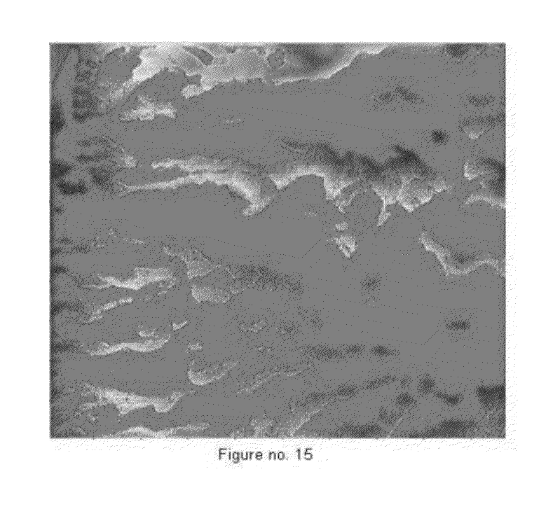

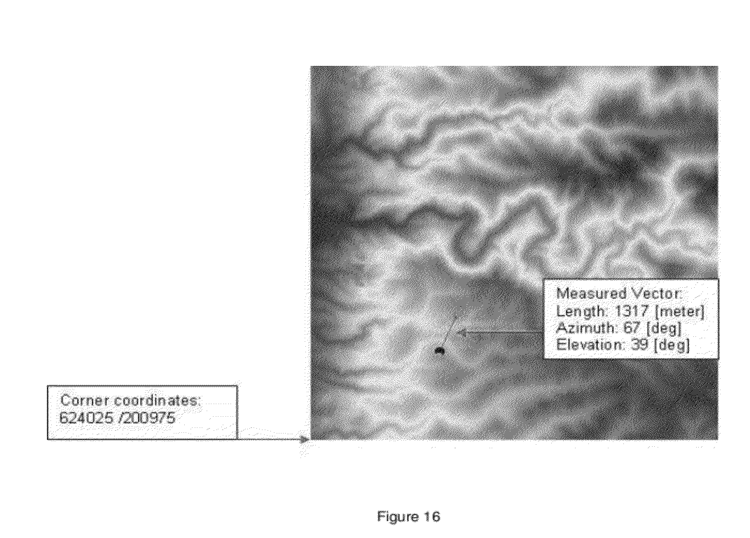

FIG. 15 represents a top view of the search process, after all the points in data base have been scanned.
c. Solution:
Since only one solution was found, the system marks the observer's position as:
Eastern: 204175
Northern: 626575

### Error Management:

The accuracy of the above process may be influenced by one or more error factors, for example according to one or more of the following causes:
Measuring devices' accuracy.
Measuring devices' resolution.
Digitized database's accuracy.
Digitized database's resolution.
The fact that the actual observer's location is not on the surface of the mapped data but is located above the mapped surface due to its own height.
The surface is covered by vegetation, buildings and other interfering objects due to human operation and changes to the landscape, which may not be fully represented in the digitized data and so which may cause some deviation to the measurement.

Therefore, although the original equation that verifies the compliance of point m with the original observer's position, while using its singular vector array, may be represented as:

(Pm1, Pm2, Pm3)+(Cn1, Cn2, Cn3)=(Smn1, Smn2, Smn3)

the actual equation preferably also accommodates the above mentioned error factor(s), by adding a delta_error vector, represented as:

(Pm1, Pm2, Pm3)+(Cn1, Cn2, Cn3)−(Smn1, Smn2, Smn3)<delta_Error

Although knowing the value of “delta_Error” variable is efficient, optionally the error variable (“delta_Error”) is not known prior to the position calculations.

In order to find the user's position, optionally only if an exact position may not be determined, a small value is optionally given to the “delta_Error” variable at the first iteration. In this first iteration, the process attempts to fulfill the above error equation and obtain the user's position. If the vectors do not comply, the “delta_Error” variable is then preferably increased for a second iteration and so forth, until the vectors comply with the error equation, which means that the position has been located.

Examples for Error Management:

The same problem to solve is as for the above mentioned test case.
Map Resolution at X,Y surface is 50 meters.
Map resolution at Z surface is 2 meters.

In this example these coordinates were used:
Self position: 204175/626575, height: 610
Vector 1 target: 204575/627525, height: 620
Vector 2 target: 204225/628425, height: 633
Vector 3 target: 203475/628225, height: 610
Vector 4 target 204625/626875, height: 617

The view point of the observer was limited to ˜90 degree in order to harden error simulation.

Table 1 below represents the number of vectors required to gain a singular solution as a factor of the allowed Distance error, Azimuth error, Elevation error or a combined error according to the resolution of the underlying digitized map, as the error cannot be smaller than the minimum map resolution.

TABLE 1

| Position | Vectors needed | | Azimuth | Distance | |
|---|---|---|---|---|---|
| Error | for Singular | Elevation Error | Error | Error | Test |
| [m] | solution | [degree] | [degree] | [m] | no. |
| <0.1 | 1 | 0 | 0 | 0 | 1 |
| <0.1 | 1 | 0.1 | 0 | 0 | 2 |
| <0.1 | 1 | 0.5 | 0 | 0 | 3 |
| 50 | 2 | 1 | 0 | 0 | 4 |
| 50 | 3 | 1.5 | 0 | 0 | 5 |
| 50 | 3 | 2 | 0 | 0 | 6 |
| 50 | 3 | 5 | 0 | 0 | 7 |
| <0.1 | 1 | 0 | 0 | 0 | 8 |
| 50 | 2 | 0 | 0.1 | 0 | 9 |
| 50 | 2 | 0 | 0.5 | 0 | 10 |
| 50 | 2 | 0 | 1 | 0 | 11 |
| 50 | 2 | 0 | 1.5 | 0 | 12 |
| 50 | 2 | 0 | 2 | 0 | 13 |
| <0.1 | 3 | 0 | 5 | 0 | 14 |
| <0.1 | 1 | 0 | 0 | 0.1 | 15 |
| <0.1 | 1 | 0 | 0 | 0.5 | 16 |
| <0.1 | 2 | 0 | 0 | 1 | 17 |
| <0.1 | 2 | 0 | 0 | 2 | 18 |
| <0.1 | 3 | 0 | 0 | 5 | 19 |
| <0.1 | 4 | 0 | 0 | 10 | 20 |
| 50 | 4 | 0 | 0 | 15 | 21 |
| 50 | 2 | 1 | 1 | 1 | 22 |

### Surface Calculation:

This calculation preferably includes calculating the surface area using Laser range finder, azimuth sensor and/or elevation sensor and calculating an area of a rectangle.

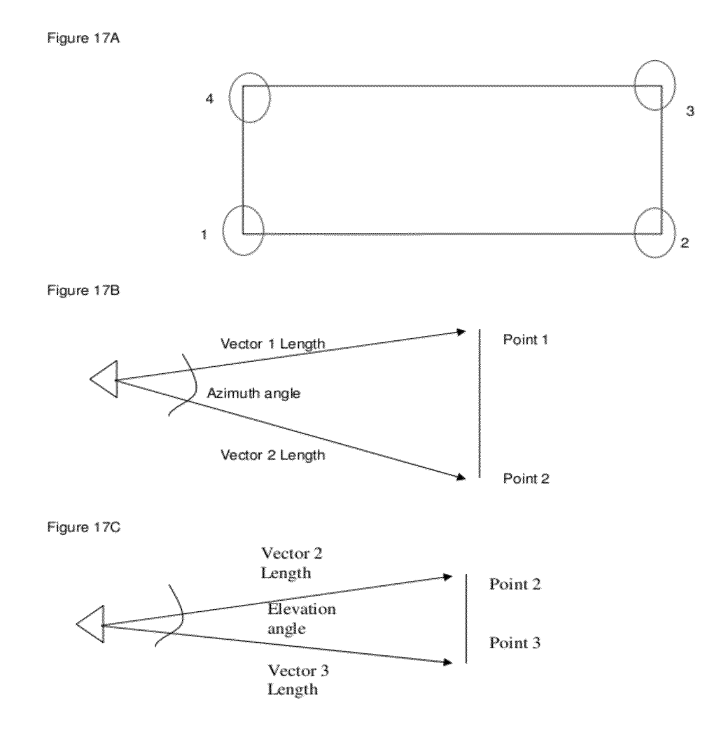

One may, for example, measure three points as shown with regard to FIG. 17A, taking range, azimuth and elevation data from measurements. A top view of the measurement process is shown in FIGS. 17B and 17C. FIG. 17B shows measurement of azimuth differences (width of the rectangle); FIG. 17C shows measurement of elevation differences (height of the rectangle) in a side view.

In order to calculate width and height the cosine is used:

Width of rectangle=sqrt(vector1 lengtĥ2+vector2 length ̂2-2*vector1 length*Vector2 length*cos (Azimuth Angle))

Height of rectangle=sqrt(Vector2 lengtĥ2+vector3 length ̂2-2*vector2 length*Vector3 length*cos (Elevation Angle))

Then width and height are multiplied to get the surface area.

Rectangular area=Width of rectangle*Height of rectangle.

It is possible to use different combinations of pairs of measurements at different points.

While the invention has been described with respect to a limited number of embodiments, it will be appreciated that many variations, modifications and other applications of the invention may be made. Also it will be appreciated that optionally any embodiment of the present invention as described herein may optionally be combined with any one or more other embodiments as described herein.

1. A method for self orientation of an object in a three dimensional environment, comprising: providing mapped data for at least a portion of the environment comprising digitized data relating to a plurality of points of said three dimensional environment; performing a plurality of linear measurements from said object to at least one other feature of the environment, wherein said plurality of linear measurements are performed along at least one clear line of sight between said object to said at least one other feature of the environment, wherein said line of sight is clear if any type of reflected electromagnetic radiation is transmissible between them; and locating the object in relation to said at least one other feature of the environment according to said plurality of linear measurements, wherein said at least one other feature is locatable in said mapped data, wherein a position of said at least one other feature is not known before said performing said plurality of linear measurements and wherein said locating the object is performed by a computer; wherein said locating the object in relation to said at least one other feature only includes performing a plurality of linear measurements; wherein said performing said plurality of measurements comprises determining at least two of a distance between the object and said at least one other feature, the relative azimuth between them, or the relative height between them; and wherein said performing said plurality of measurements comprises determining a plurality of vectors expressing said orientation relationship between the object and said at least one other feature.

2. The method of claim 1, further comprising randomly selecting said at least one other feature before performing said plurality of measurements.

3. The method of claim 1, wherein said locating the object in relation to said at least one other feature only includes performing a plurality of linear measurements, without performing any other type of measurement and without GPS data or inertial data.

4. (canceled)

5. The method of claim 1, wherein only one of height and distance, relative height and relative azimuth, or relative azimuth and distance are used.

6. The method of claim 1, wherein distance, relative azimuth and relative height are used, and said performing said plurality of measurements is performed with a range finder, a compass, and a tilt measuring device.

7. The method of claim 6, wherein said range finder is selected from the group consisting of an optical range finder, a laser range finder, an acoustic range finder and an electromagnetic range finder.

8. (canceled)

9. (canceled)

10. The method of claim 1, wherein a number of said plurality of vectors is increased for an environment having fewer distinctive features.

11. The method of claim 1, wherein said providing mapped data comprises digitizing data representative of the three dimensional surface of the environment; and describing each environmental feature in terms of a point on said surface.

12. The method of claim 11, wherein said locating the object comprises transforming a relative location to a vector structure that conforms to the coordinate system of said mapped data.

13. The method of claim 12, wherein said locating the object further comprises locating each point in said plurality of vectors that does not provide a description of a “True” point of said mapped data;
and removing each vector that does not correspond to at least one “true” point of said mapped data.

14. The method of claim 13, wherein if all vectors match a point of said mapped data, selecting said point as an optional solution to said locating the object.

15. The method of claim 14, wherein if only one optional solution is found, selecting said optional solution as a location of the object.

16. The method of claim 14, wherein if a plurality of optional solutions are found, calculating a line of sight for each vector, such that if said line of sight is not present between said at least one other feature of the environment and said optional solution, rejecting said optional solution as a false solution.

17. The method of claim 16, wherein said calculating said line of sight comprises searching through a plurality of points and determining a plurality of vectors for said points; comparing z values of vectors to z values of said mapped data; and if z values of said mapped data which are on the path of a proposed view point line are greater than the z value of the linear line of the view point, then there is no viewpoint.

18. The method of claim 1, wherein providing said mapped data comprises one or more of providing a matrix of mapped data, a table of mapped data, normalized mapped data, sorted mapped data or compressed mapped data, vector mapped data, DTM (digital terrain model) mapped data, DEM (digital elevation model) mapped data, DSM (digital surface model) mapped data or a combination thereof.

19. The method of claim 18, wherein said locating the object comprises searching through a plurality of points.

20. The method of claim 19, wherein said searching through said plurality of points comprises eliminating points having a distance greater than a range of a range finder.

21. The method of claim 20, wherein said searching through said plurality of points comprises eliminating points having greater than a maximum height and less than a minimum height relative to a measured height.

22. The method of claim 21, wherein said computer comprises a thin client in communication with a remote server and wherein said searching through said plurality of points is performed by said remote server.

23. The method of claim 22, wherein said computer further comprises a display screen, the method further comprising displaying a result of locating the object on said display screen.

24. The method of claim 1, wherein the environment comprises high feature terrain having at least 3 features per square kilometer and wherein said performing said plurality of linear measurements from said object comprises performing said plurality of linear measurements from said object to at least 1 feature.

25. The method of claim 1, wherein the environment comprises low feature terrain having at least 1 feature but fewer than 2 features per square kilometer and wherein said performing said plurality of linear measurements from said object comprises performing said plurality of linear measurements from said object to at least 3 features.

26. The method of claim 1, wherein the environment comprises medium feature terrain having at least 2 features but fewer than 3 features per square kilometer and wherein said performing said plurality of linear measurements from said object comprises performing said plurality of linear measurements from said object to at least 2 features.

27. The method of claim 1, wherein the object is located at a location selected from at least one of air, ground or sea, and wherein the feature is located at a location selected from at least one of ground or sea.

28. The method of claim 1, wherein said locating the object comprises performing an error correction on one or more of said measurements and/or said mapped data, and searching through said mapped data according to said plurality of measurements and said error correction.

29. The method of claim 28, wherein said providing said mapped data comprises providing an initial error estimate for said mapped data;
and wherein said performing said error correction is performed with said initial error estimate.

30. The method of claim 29, wherein said performing said plurality of linear measurements comprises determining an initial measurement error; and wherein said performing said error correction is performed with said initial measurement error.

31. The method of claim 1, wherein said environment comprises an urban environment or a field environment.

32. The method of claim 1, further comprising determining at least one clear line of sight between said object to said at least one other feature of the environment before said performing said plurality of measurements.

33. The method of claim 32, wherein said determining said at least one clear line of sight comprising performing a line of sight algorithm for all points of said mapped data and storing results of said line of sight algorithm.

34. A method for self orientation of an object in a three dimensional environment, comprising: providing mapped data for at least a portion of the environment comprising digitized data relating to a plurality of points of said three dimensional environment; performing a plurality of linear measurements from said object to at least one other feature of the environment, wherein said plurality of linear measurements are performed along at least one clear line of sight between said object to said at least one other feature of the environment; and locating the object in relation to said at least one other feature of the environment according to said plurality of linear measurements, wherein said at least one other feature is locatable in said mapped data, wherein a position of said at least one other feature is not known before said performing said plurality of linear measurements, wherein said locating the object is performed by a computer and with the proviso that said performing said plurality of measurements and/or said locating the object is not performed with an imaging device.

35. A method for self orientation of an object in a three dimensional environment, comprising: providing mapped data for at least a portion of the environment comprising digitized data relating to a plurality of points of said three dimensional environment; performing a plurality of linear measurements from said object to at least one other feature of the environment, wherein said plurality of linear measurements are performed along at least one clear line of sight between said object to said at least one other feature of the environment; and locating the object in relation to said at least one other feature of the environment according to said plurality of linear measurements, wherein said at least one other feature is locatable in said mapped data, wherein a position of said at least one other feature and a relative orientation between the object and said at least one other feature is not known before said performing said plurality of linear measurements, wherein said locating the object is performed by a computer.

36. An apparatus for performing the method according to claim 1, said apparatus comprising a plurality of measurement devices for determining an orientation relationship between the object and said at least one other feature of the environment; a display screen for displaying said orientation relationship; and a processor for performing a plurality of calculations for locating the object in said mapped data according to the method of the above claims in order to determine said orientation relationship.

37. The apparatus of claim 36, wherein said plurality of measurement devices comprises a distance measuring device; an azimuth measuring device; and an inclination measuring device.

38. The apparatus of claim 37, wherein said distance measuring device comprises a range finder.

39. The apparatus of claim 38, wherein said range finder is selected from the group consisting of an optical range finder, a laser range finder, an acoustic range finder and an electromagnetic range finder.

40. The apparatus of claim 39, wherein said azimuth measuring device comprises a compass with digital output.

41. The apparatus of claim 40, wherein said compass comprises a magnetic compass, a gyrocompass or a solid state compass.

42. The apparatus of claim 41, wherein said inclination measuring device comprises a tilt sensor with digital output.

43. The apparatus of claim 42, further comprising a memory device for storing said mapped data.

44. The apparatus of claim 43, further comprising a frame on which said measurement devices are mounted, such that said measurement devices are aligned and share a common reference point.

45. Observation equipment comprising the apparatus of claim 44.

46. A system comprising the apparatus of claim 44, and a central server for performing calculations on said mapped data.
